(19) United States
(12) Patent Application Publication
(10) Pub. No.: US 2017/0122856 A1
(43) Pub. Date: May 4, 2017

(54) HARDNESS TESTING APPARATUS AND HARDNESS TESTING METHOD

(71) Applicant: MITUTOYO CORPORATION, Kanagawa (JP)

(72) Inventor: Fumihiko KOSHIMIZU, Zama (JP)

(73) Assignee: MITUTOYO CORPORATION, Kanagawa (JP)

(21) Appl. No.: 15/285,632

(22) Filed: Oct. 5, 2016

(30) Foreign Application Priority Data
Nov. 4, 2015 (JP) 2015-216263

(51) Int. Cl. G01N 3/42

(52) U.S. Cl. CPC G01N 3/42

(57) ABSTRACT

A hardness tester includes a correlation memory storing correlation data which associates hardness of a standard reference sample based on dimensions of an indentation formed by pressing an indenter into a surface of the standard reference sample, and hardness of the standard reference sample based on test force and depression amount during formation of the indentation in the standard reference sample. A CPU measures the test force and depression amount during formation of the indentation in a measured sample; calculates an estimated value of the hardness of the measured sample based on the measured test force and depression amount; and calculates the hardness of the measured sample based on the calculated estimated value and the correlation data.

### CROSS-REFERENCE TO RELATED APPLICATIONS

The present application claims priority under 35 U.S.C. §119 of Japanese Application No. 2015-216263, filed on Nov. 4, 2015, the disclosure of which is expressly incorporated by reference herein in its entirety.

### BACKGROUND OF THE INVENTION

1. Field of the Invention

The present invention relates to a hardness tester and to a hardness testing method.

2. Description of Related Art

A conventional hardness tester is known which measures hardness of a sample based on dimensions of an indentation formed by pressing an indenter against the sample with a predetermined test force (see, for example, Japanese Patent Laid-open Publication No. 2008-180669). For example, a Vickers hardness tester measures a length of diagonal lines of an indentation after the indentation is formed by pressing a square pyramidal indenter into a surface of the sample, and calculates hardness based on the measured length of the diagonal lines of the indentation.

However, in a hardness calculation method requiring such measurement of the formed indentation in order to measure hardness, observation via an optical observation device is necessary after formation of the indentation. This takes time before calculating the hardness, which results in unfavorable work efficiency.

### SUMMARY OF THE INVENTION

The present invention provides a hardness tester and hardness testing method capable of increasing work efficiency by calculating hardness without requiring optical observation.

In order to resolve the above-noted issue, one aspect of the present invention is a hardness tester loading a predetermined test force on an indenter and pressing the indenter into a surface of a sample to form an indentation. The hardness tester includes a memory, a measurer, an estimated value calculator, and a hardness calculator. The memory stores correlation data which associates hardness of a standard reference sample based on dimensions of the indentation formed by pressing the indenter into the surface of the standard reference sample, and hardness of the standard reference sample based on test force and depression amount during formation of the indentation in the standard reference sample. The measurer measures the test force and depression amount during formation of the indentation in a measured sample. The estimated value calculator calculates an estimated value of the hardness of the measured sample based on the test force and depression amount measured by the measurer. The hardness calculator calculates the hardness of the measured sample based on the estimated value calculated by the estimated value calculator and the correlation data.

According to another aspect of the present invention, the hardness tester includes a Vickers hardness calculator calculating Vickers hardness of the standard reference sample based on the dimensions of the indentation formed by pressing the indenter into the surface of the standard reference sample. The measurer continuously measures the test force and depression amount during formation of the indentation in the standard reference sample. The estimated value calculator calculates, as an estimated value, a hardness equivalent to the Vickers hardness of the standard reference sample based on the test force and depression amount measured by the measurer. The memory associates, and stores as correlation data, the Vickers hardness calculated by the Vickers hardness calculator and the estimated value calculated by the estimated value calculator.

According to another aspect of the present invention, the hardness tester includes a definer capable of setting, from among a plurality of calculation formulas, the calculation formula of the estimated value to be used by the estimated value calculator. The estimated value calculator calculates the estimated value using the calculation formula set by the definer.

Another aspect of the present invention is a hardness tester loading a predetermined test force on an indenter and pressing the indenter into a surface of a sample to form an indentation. The hardness tester includes a memory, a measurer, and a hardness calculator. The memory stores correlation data which associates hardness of a standard reference sample based on dimensions of the indentation formed by pressing the indenter into the surface of the standard reference sample, and hardness of the standard reference sample based on test force and depression amount during formation of the indentation in the standard reference sample. The measurer measures the test force and depression amount during formation of the indentation in a measured sample. The hardness calculator calculates the hardness of the measured sample based on the test force and depression amount measured by the measurer, and the correlation data.

Another aspect of the present invention is a hardness testing method performed by a hardness tester loading a predetermined test force on an indenter and pressing the indenter into a surface of a sample to form an indentation. The method includes acquisition, measurement, estimated value calculation, and hardness calculation. The acquisition acquires correlation data which associates hardness of a standard reference sample based on dimensions of the indentation formed by pressing the indenter into the surface of the standard reference sample, and hardness of the standard reference sample based on test force and depression amount during formation of the indentation in the standard reference sample. The measurement measures the test force and depression amount during formation of the indentation in a measured sample. The estimated value calculation calculates an estimated value of the hardness of the measured sample based on the test force and depression amount measured by the measurement. The hardness calculation calculates the hardness of the measured sample based on the estimated value calculated by the estimated value calculation and the correlation data.

According to another aspect of the present invention, the acquisition includes Vickers hardness calculation calculating Vickers hardness of the standard reference sample based on the dimensions of the indentation formed by pressing the indenter into the surface of the standard reference sample; preliminary measurement continuously measuring the test force and depression amount during formation of the indentation in the standard reference sample; preliminary estimated value calculation calculating, as an estimated value, a hardness equivalent to the Vickers hardness of the standard reference sample based on the test force and depression amount measured by the preliminary measurement; and storage storing correlation data which associates the Vickers hardness calculated by the Vickers hardness calculation and the estimated value calculated by the preliminary estimated value calculation.

According to another aspect of the present invention, the preliminary estimated value calculation executes one of a calculation formula finding the estimated value by substituting in the depression amount of the indenter for dimensions of the indentation, and a calculation formula finding the estimated value using indentation hardness as defined by nanoindentation.

Another aspect of the present invention is a hardness testing method loading a predetermined test force on an indenter and pressing the indenter into a surface of a sample to form an indentation. The method includes acquisition, measurement, and hardness calculation. The acquisition acquires correlation data which associates hardness of a standard reference sample based on dimensions of the indentation formed by pressing the indenter into the surface of the standard reference sample, and hardness of the standard reference sample based on test force and depression amount during formation of the indentation in the standard reference sample. The measurement measures the test force and depression amount during formation of the indentation in a measured sample. The hardness calculation calculates the hardness of the measured sample based on the test force and depression amount measured by the measurement, and the correlation data.

According to the present invention, work efficiency can be increased by calculating hardness without requiring optical observation.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is a schematic view illustrating a hardness tester according to the present invention;

FIG. 2 is a block diagram of a control structure of the hardness tester;

FIG. 3 is a flow chart illustrating a preliminary testing process of the hardness tester;

FIG. 4 is an exemplary illustration of an indentation formed by the hardness tester;

FIG. 5 is an exemplary pressing curve;

FIG. 6 is an exemplary illustration of correlation data acquired in the preliminary testing;

FIG. 7 is a flow chart illustrating a principal testing process of the hardness tester;

FIG. 8 is an explanatory diagram of an exemplary method of finding hardness using an amount of depression;

FIG. 9 is a flow chart illustrating a preliminary testing process of a modification; and

FIG. 10 is a flow chart illustrating a principal testing process of the modification.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the forms of the present invention may be embodied in practice.

Hereafter, a hardness tester and hardness testing method according to the present invention are described in detail with reference to the drawings.

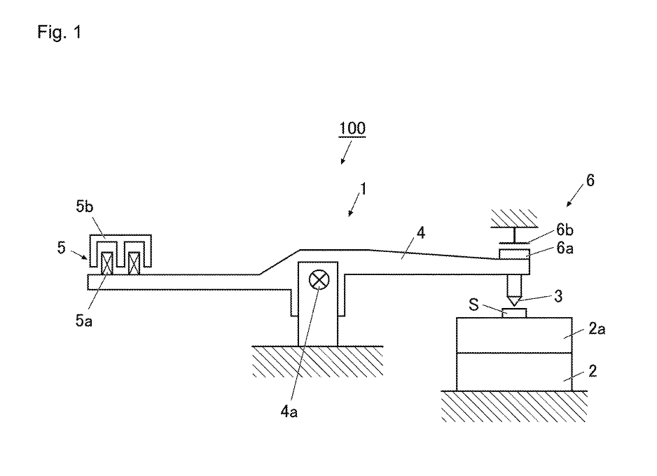

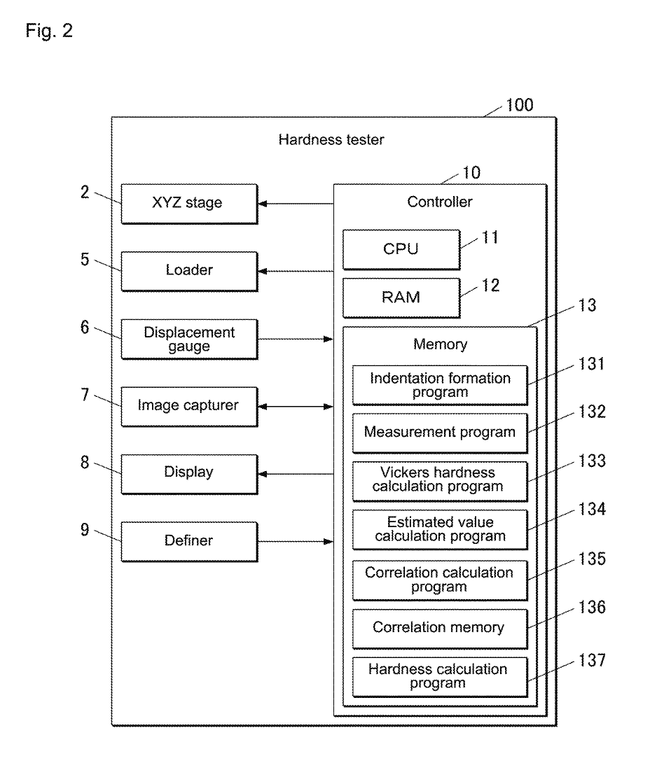

As shown in FIGS. 1 and 2, for example, a hardness tester 100 according to the present embodiment includes a controller 10 and a hardness tester main body 1 to which each component is provided. The tester main body 1 includes, for example, an XYZ stage 2 displacing a sample S in X, Y, and Z directions; a load lever 4 having at one end thereof an indenter 3, which forms an indentation in the sample S; a loader 5 placing a predetermined load (test force) on the load lever 4; a displacement gauge 6 detecting a depression amount of the indenter 3; an image capturer 7 capturing an image of the indentation formed on a surface of the sample S; a display 8; and a definer 9.

The XYZ stage 2 is configured to displace in X, Y, and Z directions (i.e., in horizontal and vertical directions) according to a control signal input from the controller 10. The sample S is displaced forward/backward, to the left/right, and upward/downward by the XYZ stage 2 so as to adjust a position of the sample S with respect to the indenter 3. In addition, the XYZ stage 2 holds the sample S with a sample holding stage 2a such that the sample S resting on an upper surface thereof does not shift during test measurement.

A quadrangular pyramidal Vickers indenter (with opposing angles of 136±0.5°) made of diamond, for example, can be used as the indenter 3. When a predetermined load is applied and the indenter 3 of this kind is pressed into the surface of the sample S, an indentation (impression) having a quadrilateral shape is formed in the surface of the sample S.

The load lever 4 is, for example, formed to be substantially pole-shaped. The load lever 4 is fixed at an approximately central portion thereof atop a stand via a cross spring 4a. The indenter 3 is provided at a first end of the load lever 4 so as to freely contact and separate from the sample S from above, the sample S resting atop the sample holding stage 2a. The indenter 3 presses against the surface of the sample S to form the indentation therein. At a second end of the load lever 4, a force coil 5a is provided, configuring the loader 5.

The loader 5 is, for example, a force motor and includes the force coil 5a attached to the load lever 4 and a fixed magnet 5b fixed so as to oppose the force coil 5a. According to a control signal input from the controller 10, the loader 5 employs a driving force to rotate the load lever 4, for example. The driving force is a force generated by electromagnetic induction between a magnetic field created in a gap by the fixed magnet 5b and an electric current flowing in the force coil 5a, which is positioned inside the gap. By rotating the load lever 4, the end of the load lever 4 on the indenter 3 side tilts downward and the indenter 3 is pressed into the sample S.

The displacement gauge 6 is, for example, an electrostatic capacitance-type displacement sensor and includes a movable polar plate 6a provided to an end of the load lever 4 on the indenter 3 side and a fixed polar plate 6b fixed in place so as to oppose the movable polar plate 6a. For example, the displacement gauge 6 detects a variation in electrostatic capacitance between the movable polar plate 6a and the fixed polar plate 6b, and thus detects the amount of displacement when the indenter 3 forms the indentation in the sample S (depression amount when the indenter 3 is pressed into the sample S). The displacement gauge 6 then outputs data on the detected amount of displacement to the controller 10. Moreover, the electrostatic capacitance-type displacement sensor is offered as an exemplary displacement gauge 6; however, the displacement gauge 6 is not limited to this and may, for example, be an optical-type displacement sensor or an eddy current-type displacement sensor.

The image capturer 7 includes, for example, a digital camera and captures an image of the indentation formed in the surface of the sample S by the indenter 3, for example, according to a control signal input from the controller 10. The image capturer 7 outputs the captured image data to the controller 10.

The display 8 is, for example, a liquid crystal display panel and performs display processing of the image of the surface of the sample S captured by the image capturer 7, various kinds of test results, and the like according to a control signal input from the controller 10.

The definer 9 is, for example, a group of operation keys such as in a keyboard and, when operated by a user, outputs an operation signal associated with that operation to the controller 10. Moreover, the definer 9 may also include a pointing device such as a mouse or a touch screen, a remote control, and other operation devices. The definer 9 is operated when the user performs an instruction input to initiate hardness testing of the sample S, when the user defines the test force (i.e., the load) placed on the indenter 3, and the like. The definer 9 is also operated when, for example, defining any of various processing modes such as a preliminary testing mode which executes preliminary testing (performed prior to actual hardness testing) and a principal testing mode which executes the actual hardness testing.

The controller 10 includes a CPU (Central Processing Unit) 11, a RAM (Random Access Memory) 12, and memory 13. Through a system bus or the like, the controller 10 is connected to the XYZ stage 2, the loader 5, the displacement gauge 6, the image capturer 7, the display 8, and the definer 9.

The CPU 11 performs various control processes according to various processing programs for use in the hardness tester that are stored in the memory 13, for example.

The RAM 12, for example, includes a program storage region for extracting the processing programs executed by the CPU 11 and a data storage region storing input data or processing results generated when the processing programs are executed.

The memory 13, for example, stores a system program executable by the hardness tester 100; various kinds of processing programs executable by the system program; data to be used when the various kinds of processing programs are executed; and data on results of the various processes calculated by the CPU 11. Moreover, programs are stored in the memory 13 in the form of a programming code that is readable by the computer. Specifically, the memory 13 stores an indentation formation program 131, a measurement program 132, a Vickers hardness calculation program 133, an estimated value calculation program 134, a correlation calculation program 135, a correlation memory 136, and a hardness calculation program 137, for example. Content of the various programs is described below.

Next, a hardness testing method of the hardness tester 100 according to the present embodiment is described.

In the hardness tester 100 according to the present embodiment, preliminary testing is performed before executing the actual hardness test. In the preliminary testing, correlation data (described below) is obtained for one or a plurality of kinds of samples serving as a standard reference (standard reference samples S1), and the correlation data is linked to characteristics of the standard reference sample S1 (such as a material) and stored. Then, when executing the actual hardness test (principal testing), in a case where a sample to be measured (measured sample) S2 has characteristics identical to the stored characteristics of the standard reference sample S1 linked to the correlation data, hardness is calculated using the correlation data.

Preliminary Testing: Acquisition

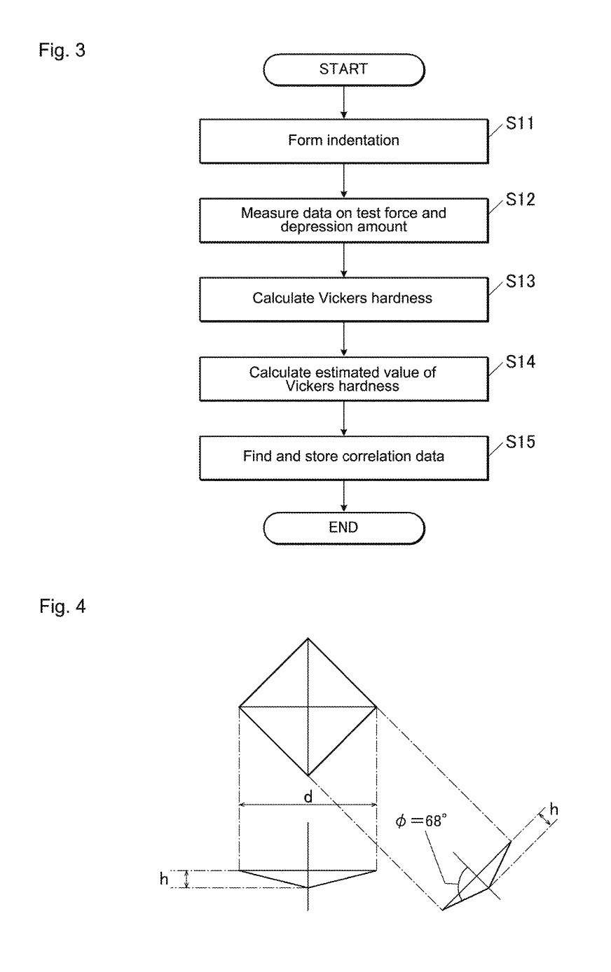

Hereafter, the preliminary testing is described in detail. FIG. 3 is a flow chart illustrating a procedural flow of the preliminary testing.

First, the preliminary testing mode is selected by the user operating the definer 9 and an instruction to initiate preliminary testing is issued in a state where the standard reference sample S1 is arranged on the sample holding stage 2a. At that point, the CPU 11 runs the indentation formation program 131 and presses the indenter 3 into the surface of the standard reference sample S1 with a predetermined test force to form an indentation in the surface of the standard reference sample S1 (step S11). FIG. 4 is a schematic view illustrating an indentation having a quadrilateral shape. In FIG. 4, a length of diagonal lines of the indentation is indicated by d and a depression amount is indicated by h.

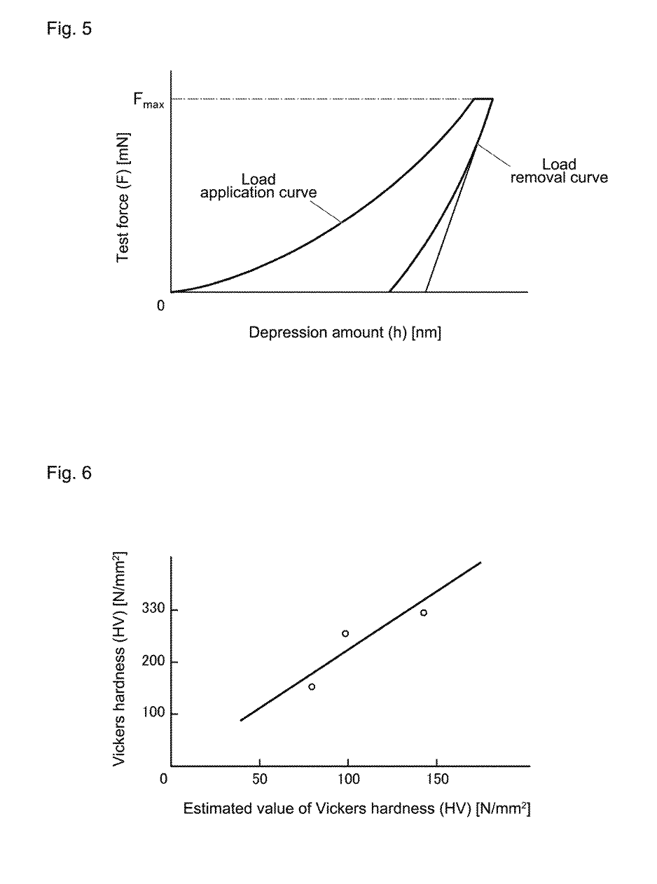

At this point, the CPU 11 runs the measurement program 132 and, during the indentation formation process, continuously acquires values for the test force loaded on the indenter 3 and the depression amount of the indenter 3, and measures data of the test force and depression amount (step S12: preliminary measurement). FIG. 5 illustrates an exemplary test force/depression amount curve (pressing curve) plotting the acquired data of the test force and depression amount. The pressing curve includes a load application curve and a load removal curve. The load application curve is measured in a load application step where a load applied to the indenter 3 is gradually increased during the indentation forming process until a defined maximum test force (Fmax) is reached. The load removal curve is measured in a load removal step where, after the load applied to the indenter 3 reaches the maximum test force, the load applied to the indenter 3 is gradually decreased.

Then, after the indentation formation ends, the CPU 11 runs the Vickers hardness calculation program 133 and calculates Vickers hardness (step S13: Vickers hardness calculation). Specifically, the CPU 11 captures image data of the indentation with the image capturer 7, measures the length of diagonal lines of the indentation using known image processing, and calculates the Vickers hardness with equation (1), below.

HV=0.1894×F/d² (1)

In this equation, HV is Vickers hardness, F is the test force, and d is the length of diagonal lines of the indentation.

Also, the CPU 11 runs the estimated value calculation program 134 and uses data on the test force and depression amount measured in step S12 to calculate hardness (step S14: preliminary estimated value calculation). Specifically, the CPU 11 converts the depression amount into the length of the diagonal lines of the indentation using equation (2), below, then substitutes the value into equation (1), above, to calculate hardness.

h=1/7d (2)

In this equation, h is the depression amount and d is the length of diagonal lines of the indentation. Thus, the hardness calculated by running the estimated value calculation program 134 is a value which estimates Vickers hardness using the depression amount, and the hardness calculated in step S14 is referred to hereafter as the “estimated value of Vickers hardness.”

Next, the CPU 11 runs the correlation calculation program 135, and associates the Vickers hardness calculated in step S13 above with the estimated value of Vickers hardness calculated in step S14 above to obtain correlation data; links the correlation data to a characteristic, such as the material, of the standard reference sample S1; and stores the linked correlation data in the correlation memory 136 (step S15: storage). FIG. 6 illustrates exemplary correlation data. FIG. 6 shows function data illustrating the correlation, with the Vickers hardness calculated in step S13 as the vertical axis and the estimated value of Vickers hardness calculated in step S14 as the horizontal axis.

In preliminary testing such as that described above, Vickers hardness and an estimated value of Vickers hardness can be calculated by performing a single indentation formation on the standard reference sample S1. Therefore, correlation data can be obtained in a comparatively short amount of time.

Principal Testing

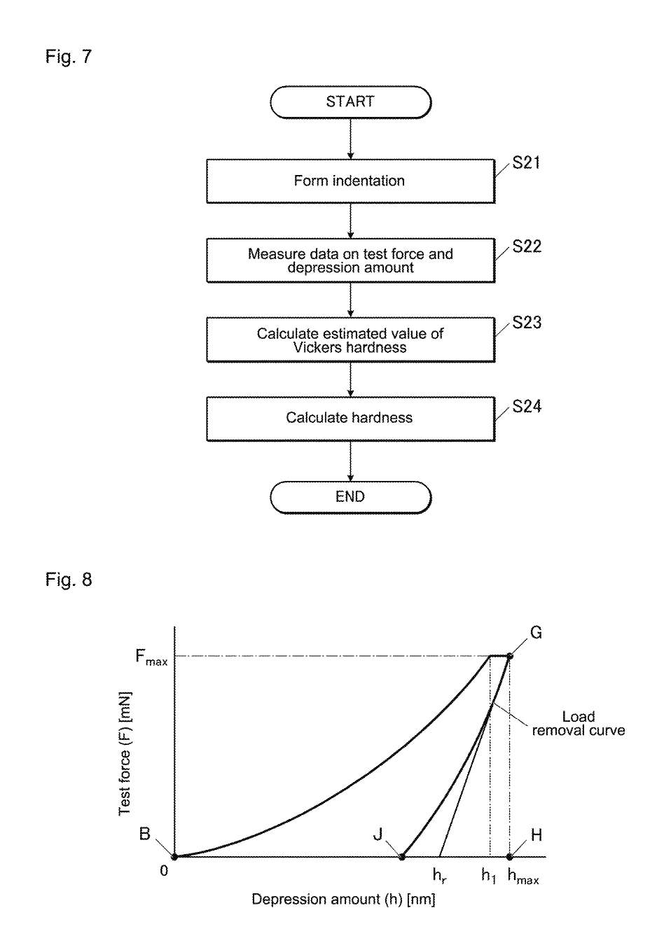

Hereafter, the actual hardness testing (principal testing) is described in detail. FIG. 7 is a flow chart illustrating a procedural flow of the principal testing. In this example, the measured sample S2 has characteristics identical to those of the standard reference sample S1, for which correlation data is stored in the correlation memory 136.

First, the principal testing mode is selected by the user operating the definer 9 and an instruction to initiate principal testing is issued in a state where the measured sample S2 is arranged on the sample holding stage 2a. At that point, the CPU 11 runs the indentation formation program 131 and presses the indenter 3 into the surface of the measured sample S2 with a predetermined test force to form an indentation in the surface of the measured sample S2 (step S21).

At this point, the CPU 11 runs the measurement program 132 and, during the indentation formation process, continuously acquires values for the test force loaded on the indenter 3 and the depression amount of the indenter 3, and measures data of the test force and depression amount (step S22: measurement).

Next, the CPU 11 runs the estimated value calculation program 134 and uses data on the test force and depression amount measured in step S22 to calculate hardness (step S23: estimated value calculation). The specific hardness calculation method is similar to that of step S14, described above, and the hardness calculated in step S23 is an estimated value of Vickers hardness using the depression amount.

Next, the CPU 11 runs the hardness calculation program 137 and calculates the hardness of the measured sample S2 based on the hardness calculated in step S23 above and on the correlation data stored in the correlation memory 136 (step S24: hardness calculation). Specifically, the CPU 11 detects the standard reference sample S1 corresponding to the measured sample S2 based on the characteristics of the measured sample S2 and obtains the correlation data linked to that standard reference sample S1. Then, the value for the hardness calculated in step S23 is applied to the correlation data and the Vickers hardness is calculated.

In principal testing such as that described above, steps S21 to S23 can be performed substantially simultaneously with indentation formation. Therefore, Vickers hardness can be calculated in the indentation formation process without needing to observe the indentation after formation, and work efficiency can be increased.

The method of calculating hardness based on the depression amount of the estimated value calculation program 134 in steps S14 and S23 is merely exemplary. The calculation method is not limited to this and examples of other calculation methods are provided below.

(Calculation Method Using Indentation Hardness (H_{IT}) with Nanoindentation)

A testing method which investigates mechanical properties of a material by continuously acquiring values for the test force loaded on the indenter 3 and the depression amount of the indenter 3 and analyzing the resulting pressing curve (see FIG. 8) is called nanoindentation, and parameters of hardness (called indentation hardness (H_{IT})) are defined by International Regulation ISO 14577. Indentation hardness (H_{IT}) may be handled as a value correlating with Vickers hardness. In this example, a method is discussed where the estimated value of Vickers hardness is calculated using a method of analyzing the indentation hardness (H_{IT}).

In FIG. 8, the vertical axis represents the test force (F), while the horizontal axis represents the depression amount (h).

The indentation hardness (H_{IT}) is defined by equation (3), below, as a value where the maximum test force (defined test force) (Fmax) is divided by a projected area of a sample in contact with an indenter during maximum depression (Ap(hc)).

H_{IT}=Fmax/Ap(hc) (3)

In addition, in the case of a Berkovic indenter, for example, Ap(hc) may be represented as in equation (4), below, based on a geometric shape of the indenter.

Ap(hc)=23.96hc² (4)

Also, hc is referred to as contact depth, and may be expressed by equation (5), below, using the maximum depression amount (hmax) and an intersection point (hr) between a line tangent to an initial portion of a load removal curve and the depression amount axis.

hc=hmax−0.75(hmax−hr) (5)

Moreover, using the geometric shape of Vickers indenter, a relationship between the Vickers hardness (HV) and indentation hardness (H_{IT}) may be expressed by equation (6), below.

HV=0.9065H_{IT} (6)

As described above, the estimated value of Vickers hardness can be calculated using equations (3) to (6).

(Calculation Method Using Brinnell Hardness)

In addition, Brinnell hardness may be found based on the test force and depression amount data, and may be used instead of the Vickers hardness. In this example, when a diameter of a sphere of the indenter used in calculating the Brinnell hardness is indicated by D and a diameter of the indentation formed by pressing against the indenter is indicated by I, the depression amount h of the indenter can be found using equation (7) below.

$$\begin{matrix}[ For mula 1 ] & \\ h = \frac{D - \sqrt{{D}^{2} - {l}^{2}}}{2} & ( 7 )\end{matrix}$$

Brinnell hardness (HB) is defined by JIS Z 2243, and can be found using the depression amount h with equation (8), below.

$$\begin{matrix}[ Formula 2 ] & \\ HB = 0.102 \frac{2 F}{π D ( D - \sqrt{{D}^{2} - {l}^{2}} )} = 0.102 \frac{F}{π Dh} & ( 8 )\end{matrix}$$

As described above, the estimated value of Brinnell hardness (equivalent to the estimated value of Vickers hardness) can be calculated using equations (7) and (8).

A configuration is also possible in which programs executing this plurality of methods of calculating the estimated value of Vickers hardness are stored in the memory 13, and the user sets the calculation method as desired using the definer 9. Specifically, a configuration in which a plurality of different programs calculating the estimated value of Vickers hardness are stored in the memory 13, and the user designates any of the calculation methods according to characteristics of the standard reference sample S1 and the measured sample S2, for example, then the CPU 11 executes the designated program and performs preliminary testing and principal testing.

According to the present embodiment, the hardness tester 100 includes a correlation memory 136 storing correlation data which associates the hardness of the standard reference sample S1 based on the dimensions of the indentation formed by pressing the indenter 3 into the surface of the standard reference sample S1, and the hardness of the standard reference sample S1 based on the test force and depression amount during formation of the indentation in the standard reference sample S1. The CPU 11 measures the test force and depression amount during formation of the indentation in the measured sample S2, calculates the estimated value of the hardness of the measured sample S2 based on the measured test force and depression amount, then calculates the hardness of the measured sample S2 based on the calculated estimated value and the correlation data. Therefore, because the hardness of the measured sample S2 can be calculated using the depression amount, hardness can be calculated in the indentation formation process without needing to observe the indentation after formation, and work efficiency can be increased.

In addition, according to the present embodiment, the CPU 11 calculates the Vickers hardness of the standard reference sample S1 based on the dimensions of the indentation formed by pressing the indenter 3 into the surface of the standard reference sample S1; continuously measures the test force and depression amount during formation of the indentation formed in the standard reference sample S1; and calculates, as an estimated value, a hardness equivalent to the Vickers hardness of the standard reference sample S1 based on the measured test force and depression amount. Then, the correlation data associating the calculated Vickers hardness and the calculated estimated value is stored in the correlation memory 136. Therefore, hardness based on the depression amount can be converted to Vickers hardness. Accordingly, Vickers hardness can be calculated in the indentation formation process without needing to observe the indentation after formation, and work efficiency can be increased.

Also, the present embodiment includes the definer 9, which is capable of setting, from among a plurality of calculation formulas, the calculation formula of the estimated value. In addition, the CPU 11 calculates the estimated value using the calculation formula set by the definer 9. Therefore, the user can set the method of calculating the estimated value in accordance with characteristics of the standard reference sample S1 and the measured sample S2, for example. Hardness can therefore be calculated more accurately.

Modification

According to the present embodiment, in the principal testing, the estimated value of the hardness of the measured sample S2 is calculated based on the test force and depression amount during formation of the indentation in the measured sample S2, and the hardness of the measured sample S2 is calculated based on the estimated value and correlation data. However, a configuration is also possible in which the hardness of the measured sample S2 is calculated based on the test force and depression amount during formation of the indentation in the measured sample S2, and on the correlation data associated with Vickers hardness.

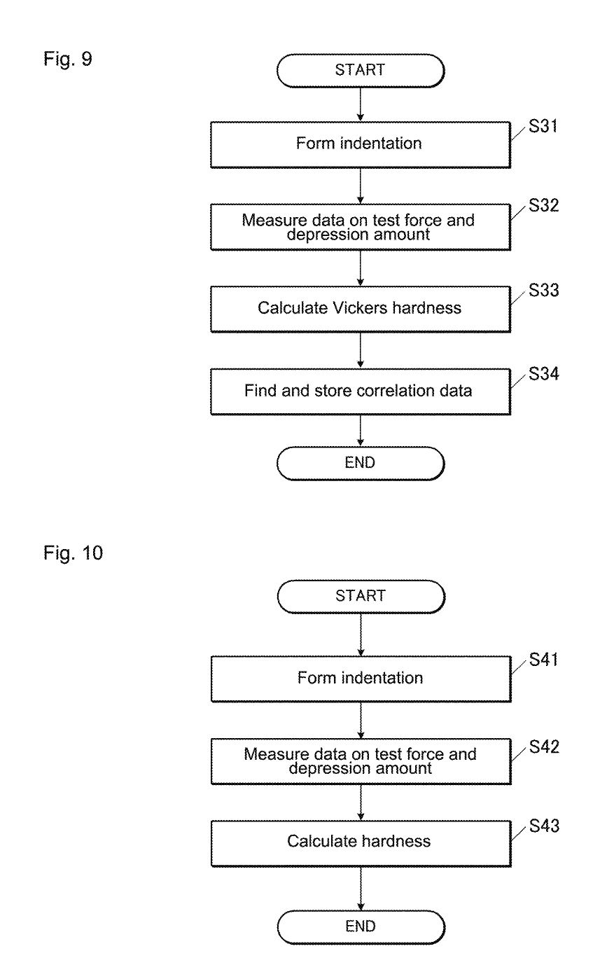

Specifically, as shown in FIG. 9, in preliminary testing (acquisition), the CPU 11 forms the indentation in the standard reference sample S1 (step S31), measures data on the test force and depression amount in the indentation formation (step S32), and calculates Vickers hardness after the indentation formation ends (step S33). Next, the CPU 11 obtains correlation data which associates the Vickers hardness of the standard reference sample S1 with the test force and depression amount during formation of the indentation in the standard reference sample S1, links the correlation data to a characteristic of the standard reference sample S1 (such as material), and stores the linked correlation data in the correlation memory 136 (step S34). After this, as shown in FIG. 10, in principal testing, the CPU 11 forms an indentation in the measured sample S2 (step S41), measures data on the test force and depression amount in the indentation formation (step S42: measurement), and calculates the hardness of the measured sample S2 based on the data measured in step S42 and on the correlation data stored in the correlation memory 136 (step S43: hardness calculation).

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

What is claimed is:

1. A hardness tester for loading a predetermined test force on an indenter and pressing the indenter into a surface of a sample to form an indentation, the hardness tester comprising:
a memory configured to store correlation data which associates hardness of a standard reference sample based on dimensions of the indentation formed by pressing the indenter into the surface of the standard reference sample, and hardness of the standard reference sample based on the test force and depression amount during formation of the indentation in the standard reference sample;
a measurer configured to measure the test force and depression amount during formation of the indentation in a measured sample;
an estimated value calculator configured to calculate an estimated value of the hardness of the measured sample based on the test force and depression amount measured by the measurer; and
a hardness calculator configured to calculate the hardness of the measured sample based on the estimated value calculated by the estimated value calculator and the correlation data.

2. The hardness tester according to claim 1, further comprising a Vickers hardness calculator configured to calculate Vickers hardness of the standard reference sample based on the dimensions of the indentation formed by pressing the indenter into the surface of the standard reference sample, wherein:
the measurer is further configured to continuously measure the test force and depression amount during formation of the indentation in the standard reference sample,
the estimated value calculator is further configured to calculate, as the estimated value, a hardness equivalent to the Vickers hardness of the standard reference sample based on the test force and depression amount measured by the measurer, and
the memory is further configured to associate, and store as the correlation data, the Vickers hardness calculated by the Vickers hardness calculator and the estimated value calculated by the estimated value calculator.

3. The hardness tester according to claim 1, further comprising a definer configured to set, from among a plurality of calculation formulas, the calculation formula of the estimated value to be used by the estimated value calculator, wherein the estimated value calculator is further configured to calculate the estimated value using the calculation formula set by the definer.

4. The hardness tester according to claim 2, further comprising a definer configured to set, from among a plurality of calculation formulas, the calculation formula of the estimated value to be used by the estimated value calculator, wherein the estimated value calculator is further configured to calculate the estimated value using the calculation formula set by the definer.

5. A hardness tester for loading a predetermined test force on an indenter and pressing the indenter into a surface of a sample to form an indentation, the hardness tester comprising:
a memory configured to store correlation data which associates hardness of a standard reference sample based on dimensions of the indentation formed by pressing the indenter into the surface of the standard reference sample, and hardness of the standard reference sample based on the test force and depression amount during formation of the indentation in the standard reference sample;
a measurer configured to measure the test force and depression amount during formation of the indentation in a measured sample; and
a hardness calculator configured to calculate the hardness of the measured sample based on the test force and depression amount measured by the measurer, and the correlation data.

6. A hardness testing method performed by a hardness tester loading a predetermined test force on an indenter and pressing the indenter into a surface of a sample to form an indentation, the method comprising:
acquiring correlation data which associates hardness of a standard reference sample based on dimensions of the indentation formed by pressing the indenter into the surface of the standard reference sample, and hardness of the standard reference sample based on test force and depression amount during formation of the indentation in the standard reference sample;
measuring the test force and depression amount during formation of the indentation in a measured sample;
calculating an estimated value of the hardness of the measured sample based on the test force and depression amount measured by the measuring; and
hardness calculation calculating the hardness of the measured sample based on the calculated estimated value and the correlation data.

7. The hardness testing method according to claim 6, wherein the acquiring further comprises:
calculating Vickers hardness of the standard reference sample based on the dimensions of the indentation formed by pressing the indenter into the surface of the standard reference sample;
continuously measuring the test force and depression amount during formation of the indentation in the standard reference sample;
calculating, as an estimated value, a hardness equivalent to the Vickers hardness of the standard reference sample based on the continuously measured test force and depression amount; and
storing the correlation data which associates the calculated Vickers hardness and the calculated estimated value.

8. The hardness testing method according to claim 7, wherein the calculating of hardness equivalent to the Vickers hardness further comprises executing one of a calculation formula finding the estimated value by substituting in the depression amount of the indenter for dimensions of the indentation, and a calculation formula finding the estimated value using indentation hardness as defined by nanoindentation.

9. A hardness testing method loading a predetermined test force on an indenter and pressing the indenter into a surface of a sample to form an indentation, the method comprising:
acquiring correlation data which associates hardness of a standard reference sample based on dimensions of the indentation formed by pressing the indenter into the surface of the standard reference sample, and hardness of the standard reference sample based on test force and depression amount during formation of the indentation in the standard reference sample;
measuring the test force and depression amount during formation of the indentation in a measured sample; and
calculating the hardness of the measured sample based on the measured test force and depression amount, and the correlation data.
